(19) United States
(12) Patent Application Publication
(10) Pub. No.: US 2008/0182695 A1
(43) Pub. Date: Jul. 31, 2008

(54) DUAL CLUTCH AXLE ASSEMBLY

(76) Inventor: Dan Joseph Showalter, Plymouth, MI (US)

Correspondence Address: BorgWarner/BHGL, P.O. Box 10395, Chicago, IL, 60610, US

(21) Appl. No.: 12/016,595

(22) Filed: Jan. 18, 2008

Related U.S. Application Data
(60) Provisional application No. 60/881,091, filed on Jan. 18, 2007.

(51) Int. Cl. F16H 48/30

(52) U.S. Cl. 475/88

(57) ABSTRACT

A rear axle assembly for a motor vehicle which includes two clutch packs to deliver torque to the right and left hand driven axle shafts of a motor vehicle. The axle assembly clutch packs are efficiently packaged within the axle housing within the inside the diameter of the axle ring gear. A single hydraulic actuator is used to apply hydraulic pressure through a closed circuit to pistons associated with each of the clutch packs to apply compressive force to the clutch packs to energize them. In this manner, the single actuator allows the axle to transfer torque between the ring gear to both the left and right hand axles.

### CROSS-REFERENCE TO RELATED APPLICATIONS

This application claims the benefit of U.S. Provisional Application Ser. No. 60/881,091 filed on Jan. 18, 2007, entitled “DUAL CLUTCH AXLE ASSEMBLY,” the entire contents of which are incorporated herein by reference.

### FIELD OF THE INVENTION

This invention relates to an axle assembly and particularly to one adapted for motor vehicle applications for providing the controlled application of torque to a pair of vehicle axles.

### BACKGROUND OF THE INVENTION

Axle assemblies for driving front or rear wheels of motor vehicles require some mechanism for allowing speed differences between the left and right hand side wheels to occur. The vehicle wheels rotate at slightly different speeds during normal operation of the vehicle and greater differences in speed occur in certain conditions, for example when the vehicle is negotiating a corner or when wheel spin occurs. The requirement for allowing speed differences between left and right hand wheels requires a driven axle assembly which accommodates the speed differences. One typical approach uses a gear differential which allows the propeller shaft or engine transaxle to deliver torque to the left and right hand axle assemblies through a gear coupling. Conventional gear differentials allow speed differences between the left and right hand axles while delivering a nearly equal torque to both. Conventional differentials have a disadvantage that equal torque between wheel sides means that insufficient tractive effort is developed in conditions where one side of the vehicle is in a low coefficient of friction contact with the road surface (or there are differences in wheel normal force, etc.) To overcome this disadvantage, differentials can incorporate clutch mechanisms which lock the left and right hand axles to provide constant rotational speed, irrespective of differing torque reaction loads acting on the two axle shafts.

Another approach to allowing speed differences between left and right hand driven axles is provided through the use of a pair of disc clutch packs which couple a driven ring gear to the left and/or right hand axle assemblies. By energizing the clutch packs, the rotation of the ring gear can be transmitted to the left and/or right hand axles. This type of dual clutch axle is typically utilized in a four-wheel drive application for the axle which is not relied upon for primary full-time traction. For example, in a four-wheel drive vehicle having a transversely mounted front engine configuration, the front transaxle would incorporate a gear differential to drive the front left and right hand axles. In the event that tractive effort is needed at the rear axle, the dual clutch axle can be energized to couple the ring gear to the left and/or right rear axles.

Rear axle assemblies in which the ring gear drives the outer clutch plates of a clutch pack, and sets of inner plates drive the two axle half-shafts, have been in production for a number of years. In this conventional configuration, the clutch packs are independently energized by a pair of electromagnetic clutches through a ball-ramp type amplification actuator device. The electromagnetic clutches utilize the difference in speed that exists whenever there is slippage between the front and the rear wheels or between wheel sides. Although such systems have a quick response, it would be beneficial to be able to engage the clutch packs prior to slip occurring, which is known in the industry as being “preemptive” traction control.

In addition to allowing preemptive actuation, reducing mass of vehicle components and decreasing their packaging space requirements are constant objectives of motor vehicle designers. This invention is related to an improved dual clutch axle assembly, particularly adapted for rear axle applications which provides benefits in the above-described areas.

### SUMMARY OF THE INVENTION

The axle assembly in accordance with the present invention incorporates a pair of clutch packs having inner and outer discs which are interleaved. The outer discs of both clutch packs are driven to rotate by the axle ring gear. A pair of separate pistons are used to compress the inner and outer plates of the clutch packs together to transmit the rotation of the ring gear to the left and right hand axle assemblies. The axle assembly in accordance with the present invention is actuated using a single hydraulic cylinder actuator which preferably is in the form of an electric motor driven master cylinder. Preferably the inner and outer clutch discs of the clutch packs are designed to have a diameter less than that of the ring gear, which enhances the packaging efficiency of the system and reduces its overall mass.

Additional benefits and advantages of the present invention will become apparent to those skilled in the art to which the present invention relates from the subsequent description of the preferred embodiment and the appended claims, taken in conjunction with the accompanying drawings.

### BRIEF DESCRIPTION OF THE DRAWINGS

FIG. 1 is a rear pictorial view of the dual clutch axle assembly in accordance with the present invention;

FIG. 2 is a longitudinal cross-sectional view of the axle assembly taken along line 2-2 from FIG. 1;

FIG. 3 is a cross-sectional view through a portion of the actuator assembly of the axle taken along line 3-3 of FIG. 1; and

FIG. 4 is a cross-sectional view taken through a pair of spool valves used to supply hydraulic pressure to the clutch pack assemblies taken along 4-4 from FIG. 1.

### DETAILED DESCRIPTION OF THE INVENTION

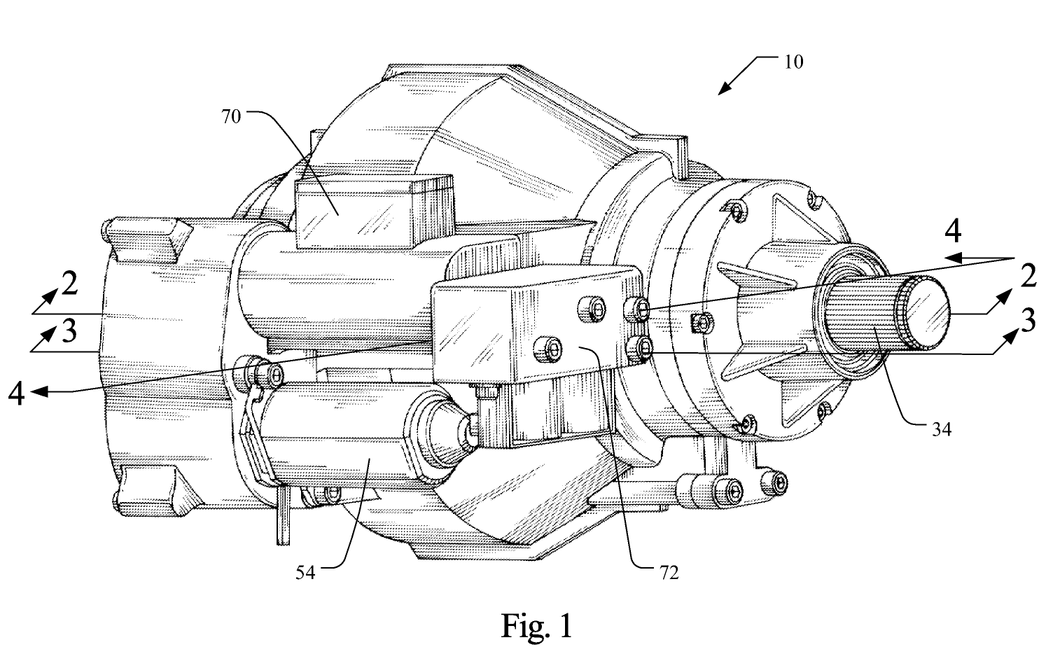

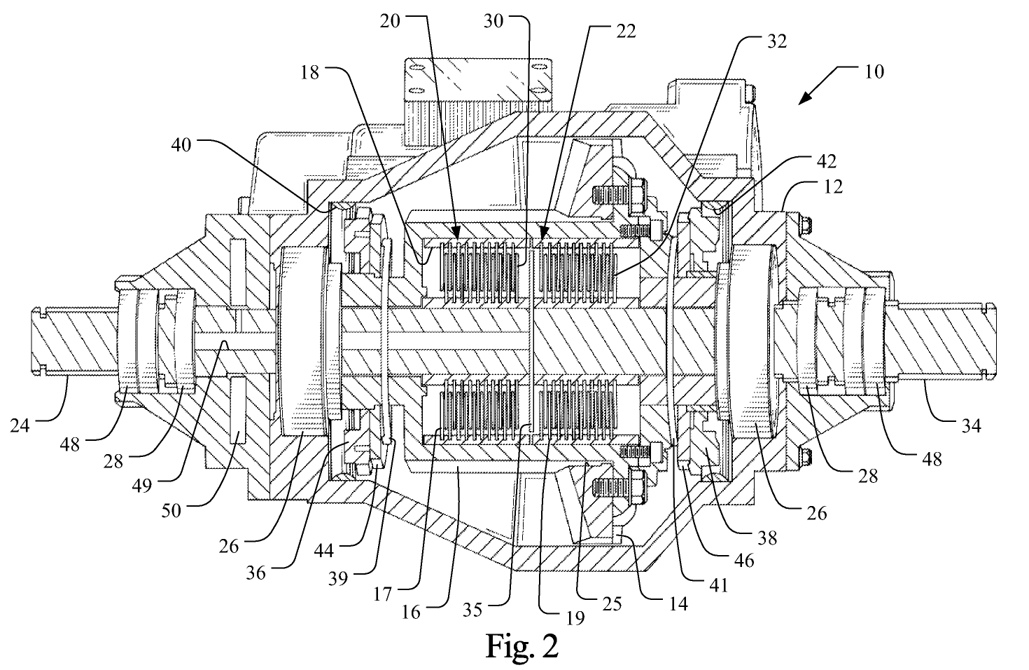

An dual clutch axle assembly incorporating the features of the present invention is shown in FIGS. 1 and 2 and is designated there by reference number 10. With particular reference to FIG. 2, the primary components of axle assembly 10 are shown. Axle assembly 10 has a housing 12 with a hollow interior cavity which accommodates the internal axle components which will be described. Ring gear 14 is driven for rotation by a pinion gear (not shown) which is coupled with the vehicle power plant through appropriate gear reduction inputs, propeller shaft, etc. Ring gear 14 rotates within the interior of housing 12. Ring gear 14 is connected (shown through threaded fasteners) to a hollow outer clutch shell 16. Ring gear 14 defines an inner diameter 25. Outer clutch shell 16 forms an inner surface 18 which is splined to receive and mesh with stacks of outer clutch discs 17 and 19 divided between the left axle clutch pack 20 and right axle clutch pack 22, respectively. The outer diameter of outer clutch discs 17 and 19 are splined to be received by outer clutch shell inner surface 18. During normal operation of the associated motor vehicle, ring gear 14 rotates continuously thereby also rotating outer clutch shell 16 and the outer discs 17 and 19 of clutch packs 20 and 22.

Left half axle (or half-shaft) 24 is supported for rotation within housing 12 by a pair of rolling element bearings 26 and 28. Left axle 24 at its inner end features a splined outer surface which receives splined inner clutch discs 30 and 32 associated with the respective clutch packs 20 and 22. In a similar manner, right axle 34 is also supported for rotation within housing 12 by a similar pair of rolling element bearings 26 and 28. Clutch center plate 35 is trapped between the axles 24 and 34 and is free to rotate relative to both axles.

Each of clutch packs 20 and 22 have respective actuation pistons 36 and 38. These pistons move within cylinders 40 and 42 and are coupled with clutch apply plates 44 and 46. Rolling element thrust bearings 39 and 41 are interposed between pistons 36 and 38 and clutch outer discs 17 and 19. This configuration allows apply plates 44 and 46 to rotate with clutch outer shell 16 while pistons 36 and 38 do not rotate. Apply pins (not shown) extend between thrust bearings 39 and 41 and the outer discs 17 and 19. Force applied by the apply plates 44 and 46 cause the inner and outer clutch discs to be compressed together against clutch center plate 35, transferring torque through fractional contact between the inner and outer discs.

One feature of this invention is the compact packaging size of axle assembly 10. This is in part attributed to utilizing an internal annular cylindrical cavity within ring gear 14 formed by outer clutch shell 16. By utilizing outer clutch discs 17 and 19, and inner clutch discs 30 and 32 having an outer diameter which is less than that of the ring gear inner diameter 25, a compact assembly can be provided. In addition to limiting the outer diameter of housing 12, this configuration also reduces the width of the axle assembly. This feature is in part provided by positioning one of the clutch packs, shown in FIG. 2, as clutch pack 22 within the plane of ring gear 14. Thus, clutch pack 22 is within the inner diameter of ring gear 14. Reducing the width of axle assembly 10 is beneficial as it allows longer length axle shafts extending to the associated driven axles, which reduces joint angles at the connected axle universal joints.

FIG. 2 also illustrates the sealing of the left and right axles 24 and 34 by pairs of oil seals 48. The internal cavity of housing 12 is flooded with gear lube which is circulated within the clutch packs 20 and 22 through drilled passage 49, the flow of which is provided through operation of gerotor pump 50. Since the clutch packs 20 and 22 are flooded with lube, they are referred to as “wet” multi-disc clutch packs.

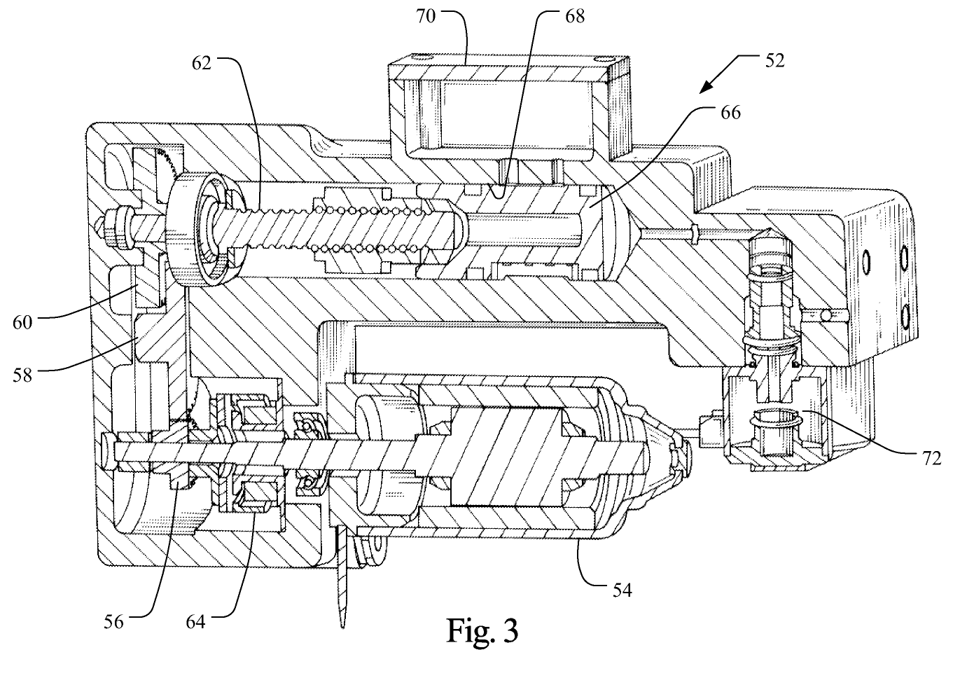

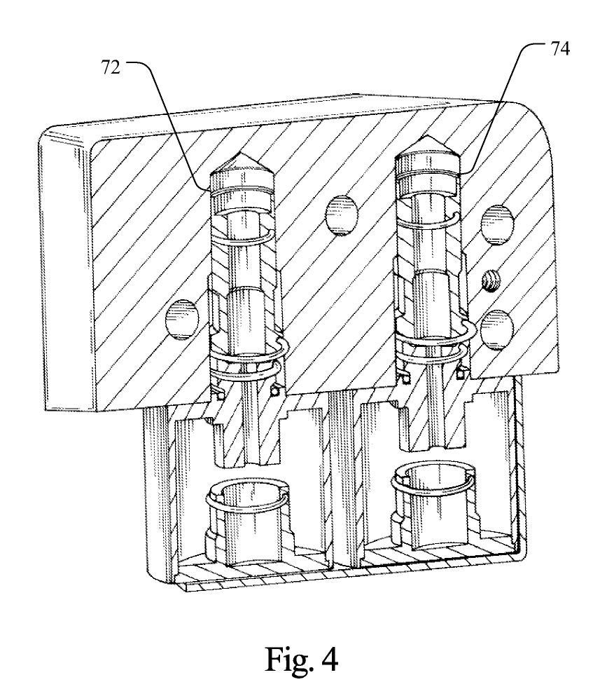

Now with particular reference to FIGS. 3 and 4, details of hydraulic actuator assembly 52 are shown. Hydraulic actuator assembly 52 provides fluid pressure to energize the clutch packs 20 and 22 by applying pressurized fluid to pistons 36 and 38. Actuator assembly 52 utilizes an electric motor 54 coupled with a series of reduction gears 56, 58, and 60 which is used to rotationally drive ball screw 62. Preferably a motor brake 64 is provided at the output shaft of electric motor 54 to enable its position to be fixed while the motor is deenergized (i.e. no electric power is supplied to the motor). Rotation of ball screw 62 causes actuator piston 66 to stroke within cylinder 68. This action allows a controlled hydraulic pressure to be generated. Hydraulic oil is supplied to cylinder 68 via reservoir 70.

Cylinder 68 communicates with a pair of spool valves 72 and 74 which are coupled with pistons 36 and 38 to apply pressure to the clutch packs. The single hydraulic actuator assembly 52 applies fluid pressure to both pistons 36 and 38 to compress and actuate both sets of clutch packs 20 and 22. In one embodiment, spool valves 72 and 74 are electromechanically operated, and allow independent control over the fluid pressure delivered to pistons 36 and 38. In another embodiment, spool valves 72 and 74 may be eliminated wherein equal pressure is applied to both pistons 36 and 38, causing equal torque to be delivered to both left and right axles 24 and 34. The fluid circuit of gerotor pump 50 circulates lube oil within the interior of housing 12 to both the clutch discs in oil and is separate from the closed hydraulic circuit of actuator assembly 52.

In operation of the associated motor vehicle, axle assembly 10 would normally be used intermittently to transmit torque to one of the front or rear axles when required. As mentioned previously, axle assembly 10 could be used at either the front or rear axle positions of a motor vehicle while the other axle would be driven for “full-time” driving torque. In many operating conditions where only two-wheel drive is required, hydraulic actuator 52 is deenergized with piston 66 retracted. In this condition, actuating pistons 36 and 38 are not compressing the clutch packs 20 and 22 against center plate 35, and therefore there is very little torque transfer from ring gear 14 to axles 24 and 34.

In conditions where torque application is required at the rear axle, electric motor 54 would be energized to drive ball screw 62 to stroke piston 66 within cylinder 68. This action applies hydraulic pressure through the actuation pistons 36 and 38 through spool valves 72 and 74, respectively. In conditions where it is desirable to lock the rear axle and rigidly connect ring gear 14 to the axles 24 and 34, the electric motor 54 could be energized to apply high pressure fluid to the pistons 36 and 38. Once reaching that condition, electric motor 54 may be deenergized (i.e. electric potential is no longer applied to the motor). In that case, the position of the piston 36 would be fixed through operation of motor brake 64.

Hydraulic actuator assembly 52 can be controlled by a vehicle powertrain controller which responds when tractive effort is required for axle assembly 10. Actuation of the clutch packs 20 and 22 can be provided without wheel slippage first occurring. Thus, the system can anticipate slippage operating conditions and is actuated, and is therefore regarded as a “preemptive” system.

While the above description constitutes the preferred embodiment of the present invention, it will appreciated that the invention is susceptible to modification, variation and change without departing form the proper scope and fair meaning of the accompanying claims.

1. An automotive axle assembly for delivering driving torque to first and second axles comprising:
a housing,
a ring gear within the housing driven for rotation,
a first clutch pack having a plurality of interleaved inner and outer first clutch disks, the first outer clutch discs coupled with the ring gear and the first inner clutch discs coupled with the first axle, and a first piston for applying a compressive force against the first clutch pack to cause the inner and outer first discs to frictionally engage thereby allowing torque to be transferred from the ring gear to the first axle,
a second clutch pack having a plurality of interleaved inner and outer second clutch disks, the second outer clutch discs coupled with the ring gear and the second inner clutch discs coupled with the second axle, and a second piston for applying a compressive force against the second clutch pack to cause the inner and outer second discs to frictionally engage thereby allowing torque to be transferred from the ring gear to the second axle,
the outer diameters of the inner and outer clutch discs of the first and second clutch packs being less than the inner diameter of the ring gear, and
hydraulic actuator means for applying fluid pressure to the first and second pistons.

2. An automotive axle assembly in accordance with claim 1, wherein the ring gear and the first and second clutch packs are enclosed within the housing.

3. An automotive axle assembly in accordance with claim 1, wherein the hydraulic actuator means applies independently controllable fluid pressure to the first and second pistons.

4. An automotive axle assembly in accordance with claim 1 wherein the actuator means comprises a master cylinder having an actuator piston driven by an electric motor.

5. An automotive axle assembly in accordance with claim 4 wherein the actuator means further comprises a first valve communicating with the first piston and a second valve communicating with the second piston, the first and second valves controlling fluid pressure applied to the first and second pistons respectively to apply independently controllable fluid pressure to the first and second pistons.

6. An automotive axle assembly in accordance with claim 4 further comprising a motor brake for allowing the position of the actuator piston to be fixed while the electric motor is deenergized.

7. An automotive axle assembly in accordance with claim 1 further comprising an outer clutch shell coupled to rotate with the ring gear, the outer clutch shell having an internal splined surface which engages the first and second outer clutch discs.

8. An automotive axle assembly in accordance with claim 1 further comprising one of the first or second clutch packs located in the plane of the ring gear and within the inner diameter of the ring gear.

9. An automotive axle assembly for delivering driving torque to first and second axles comprising:
a housing,
a ring gear within the housing and driven for rotation,
a first clutch pack having a plurality of interleaved inner and outer first clutch disks, the outer first clutch discs coupled with the ring gear and the first inner clutch discs coupled with the first axle, and a first piston for applying a compressive force against the first clutch pack to cause the inner and outer first discs to frictionally engage thereby allowing torque to be transferred from the ring gear to the first axle,
a second clutch pack having a plurality of interleaved inner and outer second clutch disks, the second outer clutch discs coupled with the ring gear and the second inner clutch discs coupled with the second axle, and a second piston for applying a compressive force against the second clutch pack to cause the inner and outer second discs to frictionally engage thereby allowing torque to be transferred from the ring gear to the second axle,
the outer diameters of the inner and outer clutch discs of the first and second clutch packs being less than the inner diameter of the ring gear, and
a hydraulic cylinder actuator having an actuator piston within a cylinder for applying fluid pressure through a first and a second valve coupled respectively to the first and second pistons, wherein the hydraulic cylinder actuator and the first and second valves cooperate to apply independently controllable fluid pressure to the first and second pistons, the cylinder actuator further having an electric motor driving a ball screw for moving the actuator piston.

10. An automotive axle assembly in accordance with claim 9, wherein the ring gear and the first and second clutch packs are enclosed within the housing.

11. An automotive axle assembly in accordance with claim 9 further comprising a motor brake for allowing the position of the actuator piston to be fixed while the electric motor is deenergized.

12. An automotive axle assembly in accordance with claim 9 further comprising an outer clutch shell coupled to rotate with the ring gear, the outer clutch shell having an internal splined surface which engages the first and second outer clutch discs.

13. An automotive axle assembly in accordance with claim 9 further comprising one of the first or second clutch packs located in the plane of the ring gear and within the inner diameter of the ring gear.
